(19) United States
(12) Patent Application Publication
(10) Pub. No.: US 2011/0023917 A1
(43) Pub. Date: Feb. 3, 2011

(54) FLOOR MAT WASHER WITH FRAGRANCE

(75) Inventor: Michael BELANGER, Novi, MI (US)

Correspondence Address: YOUNG BASILE, 3001 WEST BIG BEAVER ROAD, SUITE 624, TROY, MI, 48084, US

(73) Assignee: BELANGER, INC., Northville, MI (US)

(21) Appl. No.: 12/842,152

(22) Filed: Jul. 23, 2010

Related U.S. Application Data
(60) Provisional application No. 61/229,324, filed on Jul. 29, 2009.

(51) Int. Cl. B08B 3/00

(52) U.S. Cl. 134/61

(57) ABSTRACT

A combination automotive floor mat cleaning and fragrance applying system comprising an elongate conveyor, an infeed station made up of opposed rollers, a wet scrubber station, a hot air drying station downstream of the wet scrubber station and a fragrance applying station for applying one of several selectable fragrances to the floor mats after they are cleaned and dried.

### CROSS-REFERENCE TO RELATED APPLICATION

This application claims the benefit of U.S. provisional patent application Ser. No. 61/229,324 filed Jul. 29, 2009.

### FIELD OF THE INVENTION

This invention relates to systems for cleaning automobile floor mats and more particularly to a cleaning system which selectively applies a fragrance producing product to the floor mat after it has been cleaned.

### BACKGROUND OF THE INVENTION

Commercial car wash facilities often provide floor mat cleaning devices. One type of known floor mat cleaning device simply removes dust and dirt from a mat by beating and vacuuming while another device provides a wet scrubbing function followed by a hot air drying function. Floor mat cleaning devices may be constructed and/or situated so as to be used only by car wash employees whereas, in other cases, they may be constructed and/or situated for direct use by the customer. In the latter case, they may be activated by coins or tokens.

Commercial car wash facilities are also known to offer an interior fragrance option. The established techniques include (a) buying and placing a fragrance-saturated object somewhere in the vehicle, and (b) spraying a mist of fragrance into the vehicle at a defined point in the car washing process.

### SUMMARY OF THE INVENTION

The present invention provides the combination of a stand-alone floor mat cleaning system and a fragrance producing system which applies a spray of fragrance to the nappy side of a floor mat after it has been otherwise fully processed. This carries the fragrance into the vehicle without the introduction of an intrusive throw-away object and in such a way as to provide a relatively long lasting effect.

In accordance with the invention, the mat processing device or system may be any of several available types, one of which is illustrated and described herein as an illustrative example. In that example, floor mats are fed into the device in an inverted orientation and are conveyed by rollers through a scrubber station, a squeeze roller water elimination station, a hot air drying station and a fragrance applying station. After passing through this series of stations, the mat is available for manual pickup and reinstallation into the vehicle.

The mat processing system described above may be varied in a number of ways; for example, a vacuum station may be added to the system or substituted for the wet scrubbing and/or drying stations. Various types of conveyors or housings may be used.

In addition, the system may be set up to accept coins, bills or tokens as well as to allow the operator to select from several available fragrances or, if desired, to disable the fragrance station entirely.

### BRIEF DESCRIPTION OF THE DRAWING

The various features, advantages and other uses of the present invention will become more apparent by referring to the following detailed description and drawing in which:

The single FIGURE of drawings shows an illustrative floor mat process processing system including a wet scrubber, a hot air dryer and a multiple choice fragrance spray station.

### DETAILED DESCRIPTION OF THE ILLUSTRATIVE EMBODIMENT

In the single FIGURE, the processing system is provided for floor mats M and comprises a long grate-type support 10 for receiving mats M in an inverted; i.e., nappy side down orientation. The grating design varies along its length so as to eliminate blind spots or stripes in the cleaning function. An infeed station is provided with opposed motor-driven rubber rollers 12, 14 which are resiliently spaced apart to receive and convey the mats M toward a second set of motor driven pinch rollers 16, 18. It will be appreciated by those skilled in the art that only one roller in each set of rollers 12, 14 and 16, 18 need be motor driven while the other opposed roller may simply be an idler. The rollers in each set are close together so as to grip the mats M, but at least one roller in each set is resiliently mounted to permit mats of varying thickness to pass between them. The longitudinal distance between the roller sets 12, 14 and 16, 18 is preferably less than the total length of a mat M so that each mat is gripped and conveyed by at least one roller set at all times.

To the right of the infeed station defined by rollers 12, 14 is a scrubber station defined by a rotating brush 20 located under the conveyor grate 10 and opposed by a reaction surface 21 which prevents the mats M from lifting as the scrubber brush 20 engages the nappy downside surface thereof. The brush 20 operates in connection with a cleaning fluid reservoir 22 through which the brush passes to pick up cleaning fluid on its way to engagement with the mat. The brush 20 may rotate in either direction, a more effective cleaning action being provided if the brush rotates in opposition to movement of the mats M.

After the mats M have been scrubbed by brush 20, they pass to and between the rollers 16, 18 which provide a squeezing function to eliminate excess cleaning fluid therefrom. A catch pan may be provided as desired.

To the right of the rollers 16, 18 is a dryer station comprising a turbine 24 for causing a high volume, high speed flow of heated air through the venturi nozzle 26 which directs hot air toward the nappy side of the mat M.

To the right or downstream of the hot air dryer station is a final set of rollers 28, 30 which conveys mats to the outfeed station represented by location 32 on the grate conveyor surface 10. Beneath the outfeed station is a fragrance sprayer 34 connected to a pump powered spray device 36 which is attached to multiple plastic containers 38 containing different fragrances which may be selected by the operator/customer.

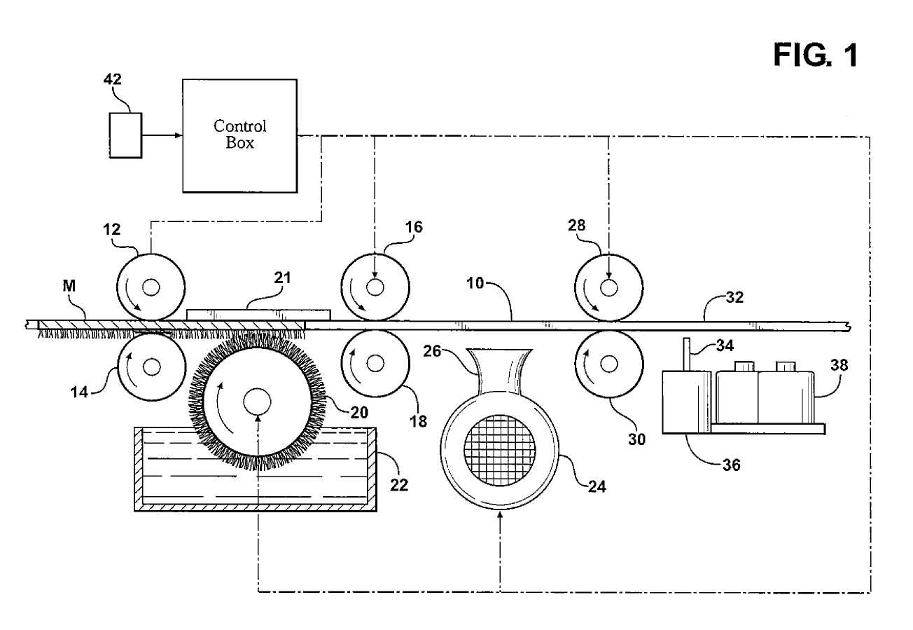

The system of FIG. 1 further comprises a control box 40 having an input device 42 which may be a coin or token receiver, a bill receiver or simply a keyboard which selects one of several available fragrances and/or allows the operator to select a “no fragrance” mode of operation. The control box 40 is connected to the motors (not shown) associated with the rollers 12, 16 and 28 as well as the rotating scrub brush 20 and a pump in the fragrance dispenser 36.

As described above, the particulars of the mat scrubbing system may vary from that shown in the drawing and described above. For example, a vacuuming station may be added or even substituted for the scrubber 20, 22. Instead of a single long conveyor 10, the conveyor may be arranged so as to reinvert the mats and send them back out into an outlet station which is on the same side of a housing as the infeed station represented by the conveyor to the left of the rollers 12 and 14. It is also possible to fold the mats. Examples of a suitable mat cleaning systems are described in expired U.S. Pat. Nos. 3,333,291, and 3,396,422. Other commercial devices are available from J-KO Company, Model Nos. U-1, UW-1, WW-2, BB-4, BB-X, CO-5, BA-5 and BT-1. Their website is www.j-kocompany.com. Suitable fragrance dispensing devices are available from a number of sources including Fragramatics Mfg. Co., Inc., whose website address is www.fragramatics.com.

What is claimed is:

1. A combination automotive floor mat cleaning and fragrance-applying system comprising:
a floor mat cleaning station;
a fragrance applying station; and
means for conveying floor mats sequentially through the cleaning and fragrance-applying stations.

2. The system defined in claim 1 wherein the cleaning station comprises a wet scrubber.

3. The system defined in claim 2 further including a floor mat drying station between the wet scrubber and the fragrance applying station.

4. The system defined in claim 1 further comprising a controller station responsive to inputs to activate the various stations of the system.

5. An automobile floor mat treatment system comprising:
a powered conveyor for receiving a floor mat in an inverted position and for conveying said mat through first, second and third sequentially, spaced-apart stations;
a mat cleaning device at the first station;
a mat drying device at the second station;
a fragrance spraying device at the third station; and
control means for activating said conveyor and said devices in selected fashions.
